(19) United States
(12) Patent Application Publication
(10) Pub. No.: US 2017/0169366 A1
(43) Pub. Date: Jun. 15, 2017

(54) Systems and Methods for Adjusting Ride-Sharing Schedules and Routes

(71) Applicant: Google Inc., Mountain View, CA (US)

(72) Inventors: Daniel Victor Klein, Pittsburgh, PA (US); Jeffrey Robert Hoy, Gibsonia, PA (US)

(21) Appl. No.: 14/967,502

(22) Filed: Dec. 14, 2015

(51) Int. Cl. G06Q 10/02; G06Q 50/30; G06Q 30/02

(52) U.S. Cl. CPC G06Q 10/025; G06Q 30/0284; G06Q 50/30

(57) ABSTRACT

Computer-implemented methods and systems for adjusting ride-sharing schedules and/or routes can include accessing a ride-sharing schedule for a ride-sharing vehicle. The ride-sharing schedule can include planned stops for one or more route locations at one or more predetermined stop times. An adjustment request seeking adjustment of one or more route locations and/or predetermined stop times of the ride-sharing schedule can be received. An adjustment cost associated with the adjustment request can be determined to provide an indication of the impact of the adjustment request to initial passengers of the ride-sharing vehicle. An adjustment request response based at least in part on the adjustment cost can be generated to provide as a notification output to indicate a decision relative to the adjustment request.

### FIELD

The present disclosure relates generally to systems and methods for adjusting ride-sharing routes and schedules, and more particularly to systems and methods for accessing initial ride-sharing routes and/or schedules to request modifications to accommodate passenger and/or vehicle flexibility in timing and pooling of transportation resources (including cars, taxis, buses, trolleys, trains, etc.).

### BACKGROUND

Vehicle congestion can be a major problem in some urban areas, and many commuter vehicles have a single occupant and are underutilized. Ride-sharing options can be effective alternatives to reduce congestion and improve energy efficiency. However, timing and pooling of transportation resources can have logistical limitations and inconveniences related to planning and execution. Many transportation options such as bus and train routes have historically operated on fixed schedules without providing any flexibility for passengers who may arrive marginally late. Carpools can be limited when passengers lack initiative to organize the carpools, are hesitant about riding with strangers, and/or do not want to be constrained to other people's schedules.

Passengers with ready access to the internet have a growing number of capabilities for ride sharing, from a spectrum of more efficient carpooling to autonomous vehicles that provide taxi services on demand, where a fleet of vehicles can be dispatched to meet user demand. The potential for real-time interaction among users and scheduling of vehicles can provide opportunities for coordinating ride sharing that were not possible before.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of adjusting ride-sharing schedules. The method can include accessing, by one or more computing devices, a ride-sharing schedule for a ride-sharing vehicle. The ride-sharing schedule can include planned stops for one or more route locations at one or more predetermined stop times. The method can also include receiving, by one or more computing devices, an adjustment request for the ride-sharing schedule, wherein the adjustment request seeks adjustment of one or more of the route locations or the predetermined stop times. The method can also include determining, by the one or more computing devices, an adjustment cost associated with the adjustment request, wherein the adjustment cost is indicative of the impact of the adjustment request to initial passengers of the ride-sharing vehicle. The method can also include generating, by the one or more computing devices, an adjustment request response based at least in part on the adjustment cost, wherein the adjustment request response includes an indication of a decision relative to the adjustment request. The method can also include providing, by the one or more computing devices, the adjustment request response as a notification output.

Another example aspect of the present disclosure is directed to a computer-implemented method of adjusting a ride-sharing route. The method can include accessing, by one or more computing devices, a ride-sharing route established for transporting one or more initial passengers in a ride-sharing vehicle from one or more pickup locations to one or more dropoff locations. The method can also include receiving, by the one or more computing devices, a ride-sharing request from one or more potential additional passengers located within a predetermined geographic proximity to the ride-sharing route. The method can also include determining, by the one or more computing devices, an impact score based at least in part on one or more factors including: an amount of additional time needed to deviate from the ride-sharing route to pick up and drop off the one or more potential additional passengers, a rerouting distance needed to deviate from the ride-sharing route to pick up and drop off the one or more potential additional passengers, or a number of initial passengers in the ride-sharing vehicle. The method can also include identifying, by the one or more computing devices, whether the impact score is less than a predetermined threshold amount. The method can also include providing, by the one or more computing devices, a notification output to the one or more initial passengers of the ride-sharing request when the impact score is less than the predetermined threshold amount.

Other example aspects of the present disclosure are directed to systems, apparatus, tangible, non-transitory computer-readable media, user interfaces, memory devices, and electronic devices for estimating restaurant wait times and/or food serving times using mobile computing devices.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 provides an example overview of adjusting ride-sharing schedules according to example aspects of the present disclosure;

FIG. 2 depicts a first exemplary user interface for adjusting ride-sharing schedules according to example aspects of the present disclosure;

FIG. 3 depicts a second exemplary user interface for adjusting ride-sharing schedules according to example aspects of the present disclosure;

FIG. 4 depicts a third exemplary user interface for adjusting ride-sharing schedules according to example aspects of the present disclosure;

FIG. 5 depicts a fourth exemplary user interface for adjusting ride-sharing schedules according to example aspects of the present disclosure;

FIG. 6 provides a flow chart of an example method of adjusting ride-sharing schedules according to example aspects of the present disclosure;

FIG. 7 provides a flow chart of an example method of determining an adjustment cost associated with an adjustment request according to example aspects of the present disclosure;

FIG. 8 provides a first example overview of adjusting a ride-sharing route according to example aspects of the present disclosure;

FIG. 9 provides a second example overview of adjusting a ride-sharing route according to example aspects of the present disclosure;

FIG. 10 provides a flow chart of an example method of adjusting a ride-sharing route according to example aspects of the present disclosure;

FIG. 11 provides an example overview of system components for implementing methods of adjusting ride-sharing schedules and ride-sharing routes according to example aspects of the present disclosure;

FIG. 12 provides an example overview of computing device components for a mobile device associated with a passenger according to example aspects of the present disclosure; and

FIG. 13 provides an example overview of scheduling system computing device components for a central scheduling system and/or vehicle scheduling system according to example aspects of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

In some embodiments, a user may not receive the benefits or be included in the techniques described herein unless they select a setting and/or install one or more applications, drivers, etc. In some embodiments, a user may be provided with controls allowing the user to make an election as to both if and when systems, programs or features described herein may enable collection of user information (e.g., user preferences and/or current location of a user), and if the user is sent content or communications from a server. In addition, certain data may be treated in one or more ways before it is stored or used, so that personally identifiable information is removed. For example, a user's identity may be treated so that no personally identifiable information can be determined for the user. Thus, the user may have control over what information is collected about the user, how that information is used, and what information is provided to the user.

Example aspects of the present disclosure are directed to systems and methods of adjusting ride-sharing routes and schedules. Ride-sharing solutions such as mass transit bus routes and carpooling provide a useful alternative to reduce vehicle congestion and improve energy efficiency in urban areas. In order to enhance the availability and effectiveness of ride-sharing options, improved online tools are needed for the coordination and modification of ride-sharing routes and schedules. A need exists for online systems and methods that can efficiently and effectively integrate scheduling needs of multiple passengers into one or more ride-sharing route and schedule opportunities. In addition, systems and methods are needed for accessing initial ride-sharing routes and/or schedules to request modifications to accommodate passenger flexibility in timing and pooling of transportation resources.

Some embodiments according to example aspects of the present disclosure can access a ride-sharing schedule for a ride-sharing vehicle (e.g., a bus, car, van, truck, train, taxi, light rail, trolley, autonomous vehicle, etc.) The ride-sharing schedules can include planned stops for one or more route locations including pickup and dropoff locations at one or more predetermined stop times. Ride-sharing schedules can be electronically accessible from an online database or central server hosting published schedule information. Alternatively, ride-sharing schedules can be compiled from relevant data sources using data extraction techniques such as web-scraping, email parsing, and the like. In still other examples, ride-sharing schedules can be dynamically created among one or more initial passengers using online reservation creation tools.

An adjustment request for adjusting one or more criteria of an initial ride-sharing schedule (e.g., a route location and/or predetermined stop time) can be received from a potential additional passenger and/or from the ride-sharing vehicle. One example scenario in which an adjustment request can be desired is when a potential additional passenger is walking to his route location (e.g., a bus stop) and he determines that he will arrive fractionally late relative to a predetermined stop time for the ride-sharing vehicle. In some examples, a determination that a potential additional passenger will be late can be estimated manually and communicated to a central server location. In other examples, a determination that a potential additional passenger will be late for a predetermined stop time at a given route location can be made based in part from passenger commuting history and/or real-time passenger and vehicle geolocation information.

Adjustment requests can include a variety of data features to assist with making subsequent evaluations regarding whether to grant a request. For example, an adjustment request can include an estimated arrival time of the potential additional passenger of the ride-sharing vehicle to a predetermined route location. In other examples, an adjustment request can include a requested amount of delay time (e.g., 20 seconds) beyond an expected stop time for a ride-sharing vehicle to wait at a particular route location. In other examples, an adjustment request can include an additional fare amount willing to be paid by the potential additional passenger of the ride-sharing vehicle to obtain the requested adjustment.

Rules-based analytics can be used to automatically evaluate the adjustment request as well as additional information provided as part of the request or gathered in response to the request. Analytic evaluation can include determining an adjustment cost associated with the adjustment request. The adjustment cost can provide a quantifiable value of the impact of the adjustment request to initial passengers of the ride-sharing vehicle. The adjustment cost can be determined at least in part from selected factors including but not limited to: the estimated arrival time or delay time for a potential additional passenger requesting a schedule adjustment, an additional fare amount the potential additional passenger is willing to pay, a number of initial passengers on the ride-sharing vehicle, a number of times that the potential additional passenger of the ride-sharing vehicle has previously provided an adjustment request, whether the potential additional passenger of the ride-sharing vehicle is handicapped, approval response feedback from initial passengers of the ride-sharing vehicle indicating their preference for accepting or denying the adjustment request and/or a current state of the ride-sharing vehicle.

An adjustment request response can be generated based at least in part from the determined adjustment cost. An adjustment request response can include an indication of one or more possible decisions relative to the adjustment request, for example an indication of a decision to grant the adjustment request in full, a decision to grant the adjustment request in part, or a decision not to grant the adjustment request. In some examples, the adjustment request response can be provided as a notification output to the ride-sharing vehicle and can optionally include information such as a number of potential additional passengers that should be picked up at a route location in response to the adjustment request, a notification of an adjusted arrival time at a route location in response to the adjustment request, or a notification of an adjusted departure time at a route location in response to the adjustment request. In some examples, the adjustment request response can be provided as a notification output to a mobile device associated with the potential additional passenger of the ride-sharing vehicle. In situations when an adjustment request is not granted or only granted in part, some embodiments can include automatic initiation of a dispatch request for alternative transportation arrangements. In situations when a threshold number of potential additional passengers consistently miss a single pickup location (e.g., as identified by multiple passengers requesting stop time adjustment at the same route location), adjustments can be made to one or more stop times of the ride-sharing schedule.

According to an example embodiment, a user is making his daily commute to a bus stop and his current geographic location is determined from location sensors in a mobile device associated with the user. Scheduling information for a bus route traditionally taken by the user is electronically accessible, as well as current geographic location information for the bus of interest. Mapping applications are able to estimate from the current geographic location information and expected travel times of the bus and user whether the user will be at his bus stop after the expected stop time for the bus. A requested delay to the bus departure time can be initiated at the user's mobile device either automatically or upon manual request. Adjustment costs can be determined based on a number of relevant factors before deciding whether the user's adjustment request should be granted in full or in part or not granted. Notification output can be provided to the user's mobile device as well as a bus computing device to indicate whether requested adjustments to the stop time will be made. This dynamic adjustment of the bus schedule benefits the user by facilitating his access to a desired transportation option and also helps enhance the effectiveness of the bus capacity and fare potential.

Some embodiments according to example aspects of the present disclosure can help create and adjust a ride-sharing route established for transporting one or more initial passengers in a ride-sharing vehicle from one or more pickup locations to one or more dropoff locations. Dynamic route adjustment can occur in real time at one or more time periods including before a ride-sharing vehicle is dispatched, while the ride-sharing vehicle is en route to the one or more pickup locations of the initial passengers, and/or while the ride-sharing vehicle is en route to the one or more dropoff locations of the initial passengers.

Adjustments to a ride-sharing route can be potentially initiated, for example, upon receipt of a ride-sharing request from one or more potential additional passengers located within a predetermined geographic proximity to the ride-sharing route. Before initial passengers are made aware of the ride-sharing request, an impact score based on combinations of one or more relevant factors can be determined. For instance, an impact score can be based at least in part on such factors as an amount of additional time needed to deviate from the ride-sharing route to pick up and drop off the one or more potential additional passengers, a rerouting distance needed to deviate from the ride-sharing route to pick up and drop off the one or more potential additional passengers, a number of initial passengers in the ride-sharing vehicle, user preferences of the one or more initial passengers and/or whether there is additional passenger capacity in the ride-sharing vehicle at the time the ride-sharing request is received or at the time the potential additional passenger is requesting pickup.

If the determined impact score is less than a predetermined threshold amount, then a notification output can be provided to the initial passenger(s) informing them of the ride-sharing request. In some examples, comparison of the impact score to a threshold amount involves comparing the impact score with a price value associated with the initial passenger(s). The price value can be related to an adjustment in fare amount available to the initial passenger(s) for accepting the ride-sharing request of the potential additional passenger(s). In some examples, the notification output provided to the initial passenger(s) includes an expected amount of additional time needed to deviate from the ride-sharing route to pick up and drop off the potential additional passenger(s) and a fare adjustment amount available to the initial passenger(s) for accepting the ride-sharing request of the potential additional passenger(s). In some examples, the notification output provided to the initial passenger(s) includes one or more profile demographics of the one or more potential additional passenger(s).

Instructions can be received from the initial passenger(s) indicating their response to the notification output, namely whether they choose to accept or reject the ride-sharing request of the potential additional passenger(s). If instructions are received indicating that all or a majority of the initial passenger(s) have accepted the ride-sharing request, then the ride-sharing route can be modified to add one or more pickup locations and one or more dropoff locations associated with the potential additional passenger(s).

According to an example embodiment, a ride-share scheduling system has access to a ride-sharing route and schedule that has been set up in advance or is currently being implemented. The ride-sharing route includes one or more initial passengers, and a determination is made that there is or will be additional capacity in the ride-sharing vehicle for one or more potential additional passengers. A ride-sharing request is received from a potential additional passenger in proximity to the ride-sharing route. Relevant, real-time information such as the pickup location and dropoff location of the potential additional passenger and the effect that these locations would have on a ride-sharing route can be weighed against a potential cost savings to the initial passengers in making a decision to relay the ride-sharing request to initial passengers for potential approval. Additional information from initial passengers including passenger preferences, cost preferences, and other voting or feedback can be utilized in making a determination about whether to grant the ride-sharing request.

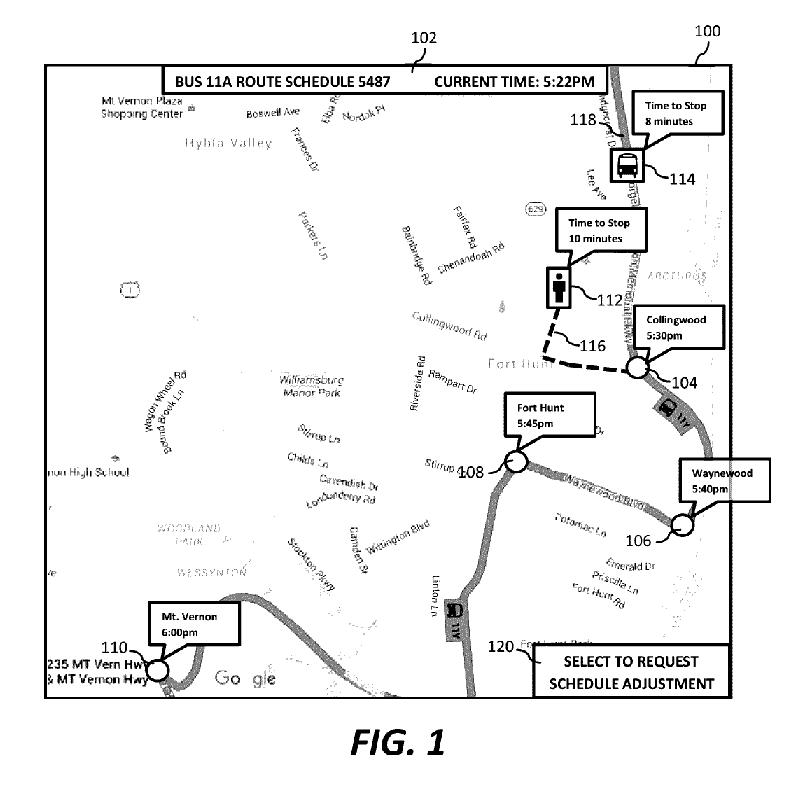

Referring now to the drawings, exemplary embodiments of the present disclosure will now be discussed in detail. FIG. 1 provides an example overview 100 of adjusting ride-sharing schedules according to example aspects of the present disclosure. Overview 100 generally depicts a real-time user interface displaying information associated with a ride-sharing schedule 102 for a ride-sharing vehicle. The ride-sharing schedule 102 of FIG. 1 corresponds to a bus route schedule for a given bus (e.g., Route Schedule 5487 for Bus 11A). Ride-sharing schedule 102 includes planned stops for one or more route locations at one or more predetermined stop times. More particularly, ride-sharing schedule 102 includes a planned stop 104 at the “Collingwood” route location at 5:30 pm, a planned stop 106 at the “Waynewood” route location at 5:40 pm, a planned stop 108 at the “Fort Hunt” route location at 5:45 pm and a planned stop 110 at the “Mt. Vernon” route location at 6:00 pm.

The route location stops and times associated with ride-sharing schedule 102 can be accessed by a user in a variety of different electronic forms, including geographically as depicted in FIG. 1 or in an alternative map-based format. In other examples, information about a ride-sharing schedule can be electronically accessed in table form, chart form, or any other suitable data format. The information within ride-sharing schedule 102 and other aspects of overview 100 or other user interfaces disclosed herein can be provided for display to a user via a mobile device operated by or otherwise accessible to a user.

In the example of FIG. 1, a user 112 desires to ride bus 114 by being picked up at the “Collingwood” route location 104 at the planned stop time of 5:30 pm. In some examples, an intended user pickup or dropoff for a particular route location and stop time can be manually identified by a user through electronic input to a user interface. In other examples, an intended user pickup or dropoff can be identified automatically from statistical models that identify a user's normal travel schedule based on geolocation and timestamp history (e.g., a user's normal commute schedule on weekday mornings and evenings), or can be determined from calendar, email, or other information available on a user's mobile device. In still other examples, an intended user pickup or dropoff location is unknown, but geolocation information about the user and local transportation options can be used to infer user travel intent.

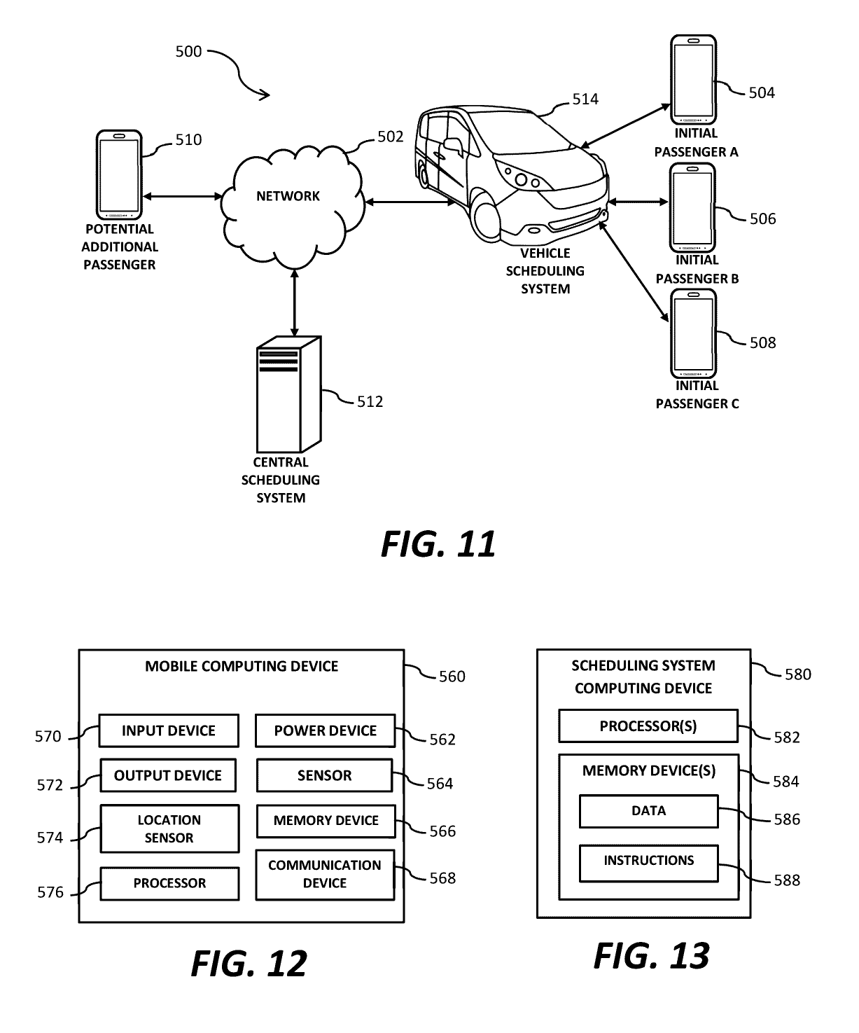

User 112 as well as ride-sharing vehicle (e.g., bus) 114 are respectively associated with computing devices configured to electronically determine geographic location and to communicate directly or indirectly with one another over one or more wired and/or wireless networks. More details regarding such computing devices will be described with reference to FIGS. 11-13. The geolocation information available from computing devices associated with user 112 and bus 114 can assist with making a determination about whether user 112 will arrive for his intended pickup at the “Collingwood” route location 104 by the planned stop time of 5:30 pm. In some examples, when geolocation information identifies that a user will be late for an intended pickup or dropoff, a computing device associated with the user 112 can be configured to receive a notification via pop-up user interface, text message, email or other communication indicating the expected late status.

Referring again to the specific example of FIG. 1, geolocation information is capable of identifying that user 112 is ten (10) minutes away from route location 104 if walking along the shortest path 116 from his current location, while bus 114 is 8 minutes away from route location 104 if traveling along the planned route 118 associated with ride-sharing schedule 102. Given the currently identified geolocation information for user 112 and bus 114, user 112 will be about two minutes late to catch his intended pickup at route location 104.

At this point, user 112 can initiate an adjustment request to bus 114 seeking adjustment of the predetermined stop time of 5:30 pm to accommodate his expected delay. The user's initiation of an adjustment request can occur in a variety of manners. For instance, a user can select an option to send an adjustment request within a website or application that is tracking the location of user 112 and/or bus 114, such as by selection of interface element 120 in FIG. 1. In some examples, an interface option for selectively sending an adjustment request can be available within a notification received by user 112 indicating the user's expected late status (e.g., where the notification includes a selectable button for sending an adjustment request).

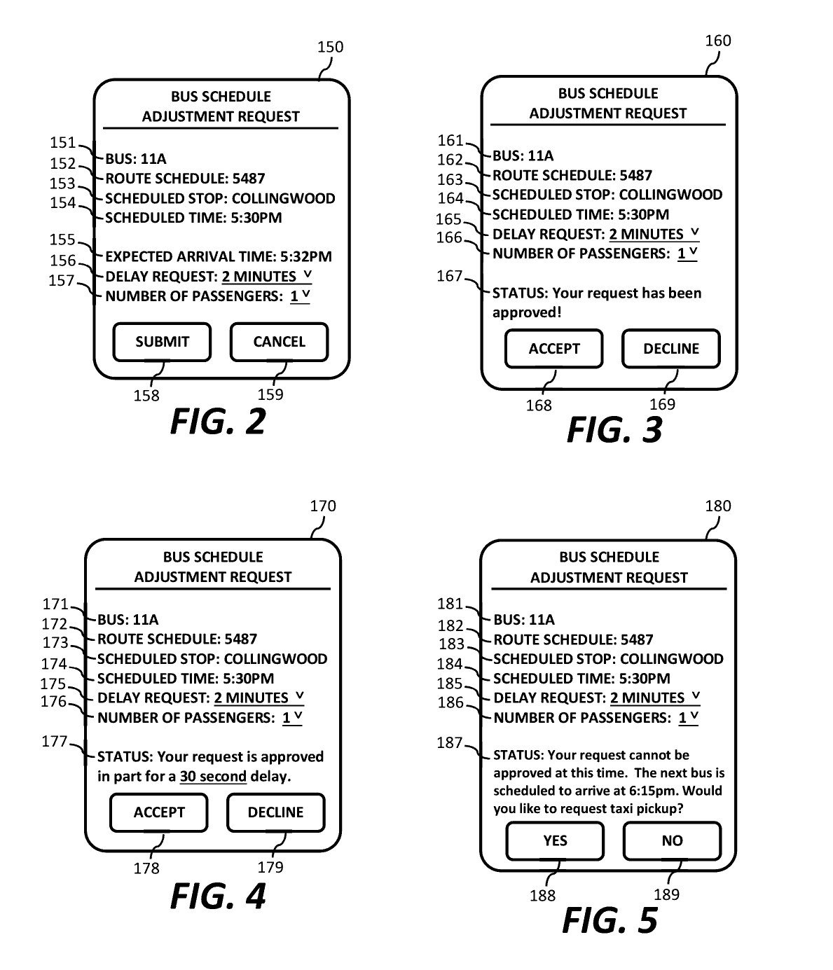

FIG. 2 shows an example of an adjustment request user interface 150, which can include an interface portion displaying details about an expected pickup or dropoff for a particular ride-sharing schedule (e.g., a ride-sharing vehicle identifier 151 for “Bus 11A,” a ride-sharing route identifier 152 for “Route Schedule 5487,” a route location identifier 153 for a scheduled stop at “Collingwood,” and a stop time identifier 154 for a scheduled time of 5:30 pm.) Adjustment request user interface 150 can also include an interface portion displaying details about an adjustment request (e.g., an expected user arrival time identifier 155 of 5:32 pm, a time amount identifier 156 for a delay request of two minutes, and a passenger number identifier 157 identifying the number of passengers for which the adjustment request is being submitted as one passenger.) Selectable interface elements such as a “Submit” button 158 and a “Cancel” button 159 can also be provided to respectively initiate or cancel the adjustment request.

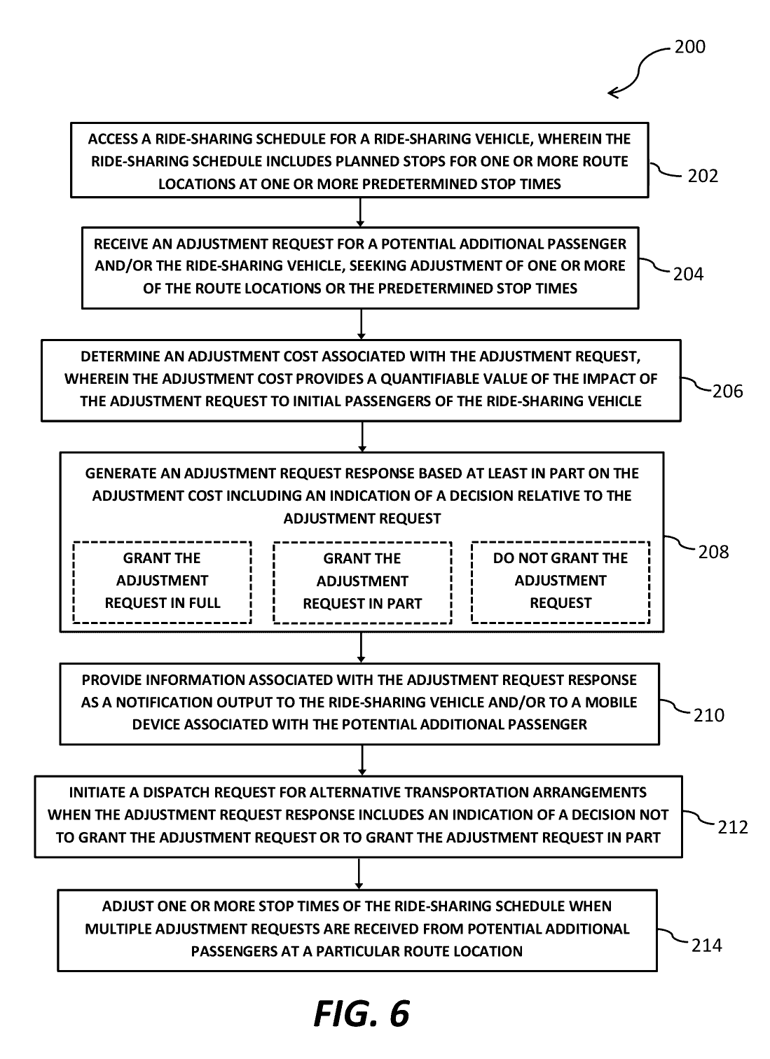

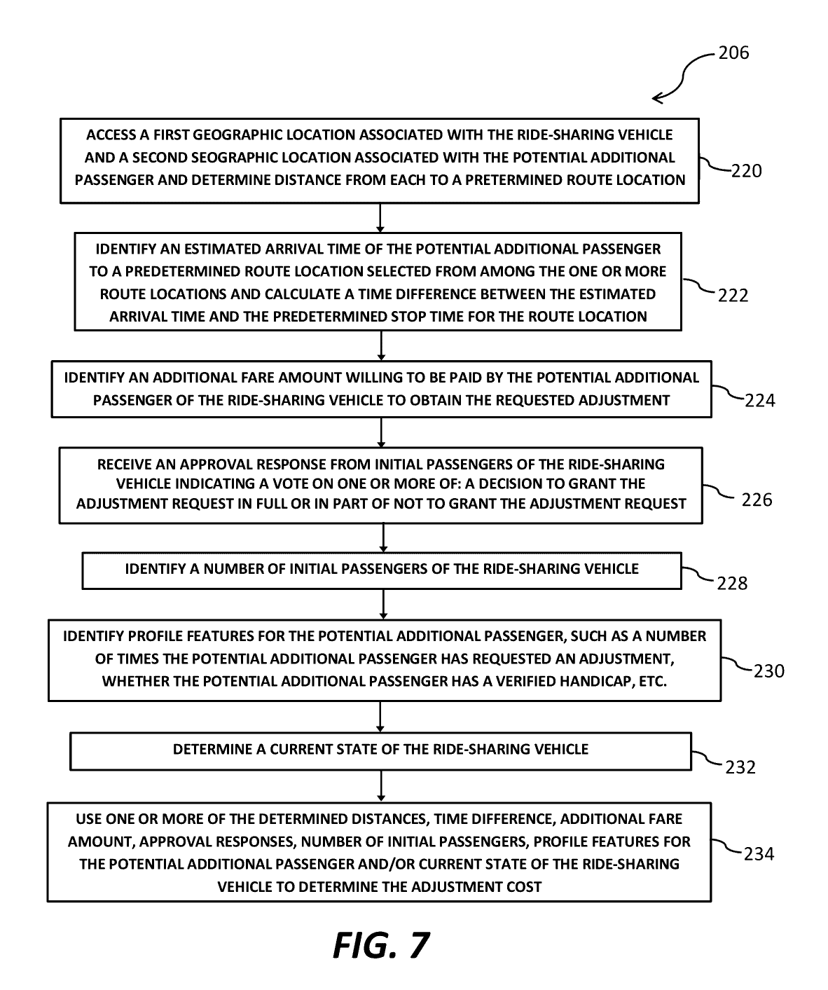

Upon receipt of an adjustment request from user 112, an adjustment cost associated with the request can be determined. An adjustment cost can be generally indicative of the impact of the adjustment request to initial passengers of the ride-sharing vehicle. Adjustment costs can be determined from statistical analysis of multiple factors, including but not limited to the amount of time delay requested by a user, profile details associated with the user 112 or other potential additional passenger, profile details associated with initial passengers of bus 114 or other ride-sharing vehicle, known details about the particular ride-sharing schedule (e.g., route location and stop time), existence of other ride-sharing schedule options (e.g., a next bus arriving 20 minutes later), a current state of the ride-sharing vehicle (e.g., bus is running 30 seconds ahead of schedule), etc. Additional details regarding the calculation of an adjustment request will be described with reference to FIGS. 6-7.

Based on the determined adjustment cost, an adjustment request response can be generated that includes an indication of a decision relative to the adjustment request. A notification output including details of the adjustment request response can then be provided for display to a user. Examples of different adjustment request responses can include an indication that the adjustment request has been granted in full, granted in part, or not granted.

FIGS. 3-5 show examples of different adjustment request response interfaces 160, 170 and 180 that can be generated relative to the specific example depicted in FIGS. 1 and 2. Referring now to FIG. 3, a first example adjustment request response interface 160 includes interactive features and information for indicating that an adjustment request has been granted in full. Adjustment request response interface 160 can include an interface portion that provides details about the adjustment request (e.g., a ride-sharing vehicle identifier 161 for “Bus 11A,” a ride-sharing route identifier 162 for “Route Schedule 5487,” a route location identifier 163 for a scheduled stop at “Collingwood,” a stop time identifier 164 for a scheduled stop time of 5:30 pm, a time amount identifier 165 for a delay request of two minutes, and a passenger number identifier 166 identifying the number of passengers for which the adjustment request is being submitted as one passenger.) Adjustment request response interface 160 also can include an interface portion that provides details about the adjustment request response, namely an adjustment request response status indicator 167 indicating that a request has been approved. Selectable interface elements such as an “Accept” button 168 and a “Decline” button 169 can also be provided to respectively accept or decline the adjustment request response.

FIG. 4 depicts a second example adjustment request response interface 170 that includes interactive features and information for indicating that an adjustment request has been granted in part. Adjustment request response interface 170 can include an interface portion that provides details about the adjustment request (e.g., a ride-sharing vehicle identifier 171 for “Bus 11A,” a ride-sharing route identifier 172 for “Route Schedule 5487,” a route location identifier 173 for a scheduled stop at “Collingwood,” a stop time identifier 174 for a scheduled stop time of 5:30 pm, a time amount identifier 175 for a delay request of two minutes, and a passenger number identifier 176 identifying the number of passengers for which the adjustment request is being submitted as one passenger.) Adjustment request response interface 170 also can include an interface portion that provides details about the adjustment request response, namely an adjustment request response status indicator 177 indicating that a request has been approved in part, granting a partial delay of 30 seconds instead of the fully requested delay amount of two minutes. Selectable interface elements such as an “Accept” button 178 and a “Decline” button 179 can also be provided to respectively accept or decline the adjustment request response.

FIG. 5 depicts a third example adjustment request response interface 180 that includes interactive features and information for indicating that an adjustment request has not been granted. Adjustment request response interface 180 can include an interface portion that provides details about the adjustment request (e.g., a ride-sharing vehicle identifier 181 for “Bus 11A,” a ride-sharing route identifier 182 for “Route Schedule 5487,” a route location identifier 183 for a scheduled stop at “Collingwood,” a stop time identifier 184 for a scheduled stop time of 5:30 pm, a time amount identifier 185 for a delay request of two minutes, and a passenger number identifier 186 identifying the number of passengers for which the adjustment request is being submitted as one passenger.) Adjustment request response interface 180 also can include an interface portion that provides details about the adjustment request response, namely an adjustment request response status indicator 187 indicating that a request cannot be approved at this time. Adjustment request response status indicator 187 also can include identifiers for the next scheduled ride-sharing option that will include the route location of interest (e.g., the next bus stopping at the Collingwood station will be Bus 11B at 6:15 pm). Selectable interface elements can be provided to initiate an optional dispatch request for alternative transportation arrangements in light of the adjustment request response being denied.

Referring now to FIG. 6, an example method (200) for adjusting ride-sharing schedules includes accessing (202) a ride-sharing schedule for a ride-sharing vehicle. Similar to the ride-sharing schedule 102 for bus 114, the ride-sharing schedule accessed at (202) can include planned stops for one or more route locations at one or more predetermined stop times. Method (200) also can include receiving (204) an adjustment request for the ride-sharing vehicle. The adjustment request received at (204) can seek adjustment of one or more of the route locations and/or the predetermined stop times. In some examples, an adjustment request received at (204) can originate from a potential additional passenger of the ride-sharing vehicle. An example adjustment request received at (204) corresponds to the adjustment request depicted in FIG. 2 submitted by user 112 of FIG. 1. In other examples, an adjustment request received at (204) can originate from the ride-sharing vehicle. This allows an operator of a ride-sharing vehicle to request delays or other route or schedule adjustments. For example, a bus that is running ahead of schedule or experiencing lighter traffic than usual can request short delays that are within the extra time it has accumulated. In other instances, a bus or other ride-sharing vehicle may desire to skip stops where there are no passengers waiting to embark and no on-board signal to debark to avoid any additional delays that could accumulate on its route.

Referring still to FIG. 6, an adjustment cost associated with the adjustment request can be determined at (206). In general, the adjustment cost determined at (206) can be indicative of the impact of the adjustment request to initial passengers of the ride-sharing vehicle and/or to the state of the ride-sharing vehicle and its route. When examples refer to “initial passenger(s)”, it should be appreciated that initial passengers could refer to current or existing passengers on a ride-sharing vehicle. In other examples, initial passengers could refer to those future passengers that are planning to be present on a ride-sharing vehicle at a time when a ride-sharing route or schedule would be impacted by a requested adjustment from a potential additional passenger. As such, initial passengers should include any passengers having an interest in a ride-sharing route and/or schedule before a potential additional passenger requests adjustment to the route and/or schedule, thus accommodating multiple potential adjustments to passenger activity over time.

FIG. 7 depicts more particular details that can be selectively implemented in various example embodiments of determining (206) an adjustment cost associated with an adjustment request received at (204). The various features depicted in FIG. 7 correspond to different adjustment cost variables that can be determined. In some examples, determining an adjustment cost (206) can include determining (220) a first travel time and a second travel time for reaching a selected route location. The first and second travel times determined at (220) can be used at least in part to determine the adjustment cost, and can more particularly include accessing a first geographic location associated with a ride-sharing vehicle, accessing a second geographic location associated with the potential additional passenger of the ride-sharing vehicle, and determining a first travel time between the first geographic location and a selected route location and a second travel time between the second geographic location and the selected route location.

In some examples, determining an adjustment cost at (206) can include identifying at (222) an estimated arrival time of the potential additional passenger of a given ride-sharing vehicle to a predetermined route location. The estimated arrival time of the potential additional passenger can be determined automatically from geolocation features available in a mobile device associated with the potential additional passenger. In some instances, the estimated arrival time of the potential additional passenger of the ride-sharing vehicle can be provided automatically or manually as part of the adjustment request. A time difference then can be calculated at (222) between the estimated arrival time of the potential additional passenger of the ride-sharing vehicle and the predetermined stop time for the predetermined route location. In other examples, a time difference can be calculated at (222) between the estimated arrival time of the potential additional passenger of the ride-sharing vehicle and an estimated arrival time of the ride-sharing vehicle based on geolocation information available from the ride-sharing vehicle.

In some examples, determining an adjustment cost at (206) can include identifying at (224) an additional fare amount willing to be paid by the potential additional passenger of the ride-sharing vehicle to obtain the adjustment request. The higher the fare amount willing to be paid by a potential additional passenger, the more likely it will be in some examples to grant the adjustment request.

In some examples, an approval response can be received at (226) from initial passengers of the ride-sharing vehicle providing voting feedback relative to the adjustment request. In some examples, approval responses received at (226) can include a specific vote on whether to grant an adjustment request in full or in part or to deny an adjustment request. In some examples, approval responses can include a more general “yes” or “no” response or an approval rating value on some predetermined scale that can be used to help determine an adjustment cost at (206) that depends in part on the vote weighting. Approval responses received at (226) can be obtained in some examples via an application available on mobile devices associated with the respective initial passengers. The more passengers that vote to approve an adjustment request, the more likely it will be in some examples that an adjustment request will be granted.

In some examples, a number of initial passengers on the ride-sharing vehicle will be identified at (228). When a higher number of passengers will be adversely affected by granting an adjustment request of a potential additional passenger, the less likely the adjustment request is to be granted. Conversely, if a ride-sharing vehicle has no passengers or a smaller number of passengers, the adjustment cost can be weighted appropriately so that it is more likely that an adjustment request will be granted.

In still further examples, one or more profile features for the potential additional passenger(s) can be identified at (230). If a profile feature is identified at (230) indicating that a potential additional passenger frequently requests adjustments, it may be less likely to grant the adjustment request. This could help prevent the same passenger from repeatedly requesting delays day after day for a particular ride-sharing vehicle and schedule. If a profile feature is identified at (230) indicating that a potential additional passenger has a handicap, then his request may be given higher priority and the adjustment cost can be weighted such that it is more likely to grant the adjustment request. In other examples, each potential additional passenger may receive a certain number of delay points or total number of adjustment requests that he can use in a given window of time as part of a profile feature identified at (230). Allotted delay points or numbers can help prevent excessive adjustment requests by any given potential additional passenger, and can also help a potential additional passenger allocate his given delay points as needed to affect a ride-sharing schedule.

In other examples, determining an adjustment cost at (206) can include determining at (232) a current state of the ride-sharing vehicle. Determining a current state of the ride-sharing vehicle at (232) can help identify an impact of the ride-sharing request on the ride-sharing vehicle and its current route and schedule. For example, a bus may have a policy that it cannot be more than two minutes behind schedule. When a current state of the bus determined at (232) indicates that the bus is running on time or ahead of schedule, the system can be configured to auto-approve all delay requests originating from the bus or optionally from potential additional passengers that delay it up to its planned schedule. In another example, a late passenger successfully requesting a one-minute delay may not be successful when a current state of the bus is determined at (232) indicating that the bus is already running late or is anticipated to be running late based on current traffic conditions.

Referring still to FIG. 7, one or more of the adjustment cost variables determined at (220)-(232), respectively, including but not limited to the first and second distances determined at (220), the time difference calculated at (222), the additional fare amount identified at (224), the approval responses received at (226), the number of initial passengers identified at (228), the profile features for the potential additional passenger identified at (230), and the current state of the ride-sharing vehicle determined at (232) can be selectively used to determine the adjustment cost at (234).

Referring again to FIG. 6, the adjustment cost determined at (206) can then be used at least in part to determine and generate an appropriate adjustment request response at (208). Potential adjustment request responses generated at (208) can include a decision to grant the adjustment request in full, a decision to grant the adjustment request in part, or a decision not to grant the adjustment request. The amount of the adjustment cost determined at (206) can be directly related to the adjustment request response generated at (208). In some examples, threshold levels can be identified for the adjustment cost to identify when different adjustment request responses should be generated. For example, adjustment costs less than a first threshold value can result in an adjustment request being granted, while adjustment costs greater than a second threshold value can result in an adjustment request being denied. Adjustment costs between the first and second threshold values can be partially approved in incremental amounts depending on the exact value of the adjustment cost.

After an adjustment request response is generated at (208), the adjustment request response can be provided as a notification output at (210) to a computing device associated with the ride-sharing vehicle and/or to a mobile device associated with the potential additional passenger. In some examples, the notification output provided at (210) can include one or more of a notification of the number of potential additional passengers that should be picked up at a route location in response to the adjustment request, a notification of an adjusted arrival time at a route location in response to the adjustment request, or a notification of an adjusted departure time at a route location in response to the adjustment request. The notification outputs provided at (210) can be provided visually on an output device such as a display screen, audibly on an output device such as a speaker, or any other appropriate feature for providing notification outputs electronically to the potential additional passenger and/or ride-sharing vehicle.

Method (200) for adjusting ride-sharing schedules can include additional optional steps, including but not limited to initiating (212) a dispatch request for alternative transportation arrangements. In some examples, user selectable interface options can be provided to a user for initiating a dispatch request at (212) when an adjustment request response includes an indication of a decision not to grant the adjustment request (similar to the adjustment request response depicted in FIG. 5) or a decision to grant the adjustment request only in part (similar to the adjustment request response depicted in FIG. 4). Alternative transportation arrangements requested at (212) can include any number of options, including but not limited to a next ride-sharing vehicle operated on a particular route (e.g., the next bus for the route location of interest), a taxi, a ride-sharing service such as Uber or the like, an autonomous vehicle, etc. In some examples, a decision to initiate a dispatch request can be dependent on an amount of time until the next scheduled ride-sharing vehicle will arrive. For instance, if the next bus will arrive in 10 minutes, a dispatch request for taxi service might not be offered as an option. In some examples, a commercial transportation provider can optionally send an electronic coupon, discount fare option, and/or advertisement to the user as part of an interface for the user to make a decision to initiate a dispatch request at (212). In other examples, if a user frequently misses his bus or other given ride-sharing vehicle, the commercial transportation provider may preemptively dispatch transportation in the case that the user will need a ride. In other examples, if multiple users miss the same pickup at a given route location, the users can be optionally and automatically enrolled in a ride-sharing option such as a taxi.

Method (200) also can include adjusting (214) one or more stop times of the ride-sharing schedule for the ride-sharing vehicle when multiple adjustment requests are received from potential additional passengers of the ride-sharing vehicle at a particular route location. For example, when a critical mass of people consistently miss a single pickup point (possibly due to transfer between modes of transit), the ride-sharing schedule system can use this information to make changes to the normal ride-sharing schedule. The ride-sharing system can also dispatch additional transportation options such as a backup bus (if available) when a large number of people miss the bus or other ride-sharing vehicle, or if the ride-sharing vehicle unexpectedly becomes full.

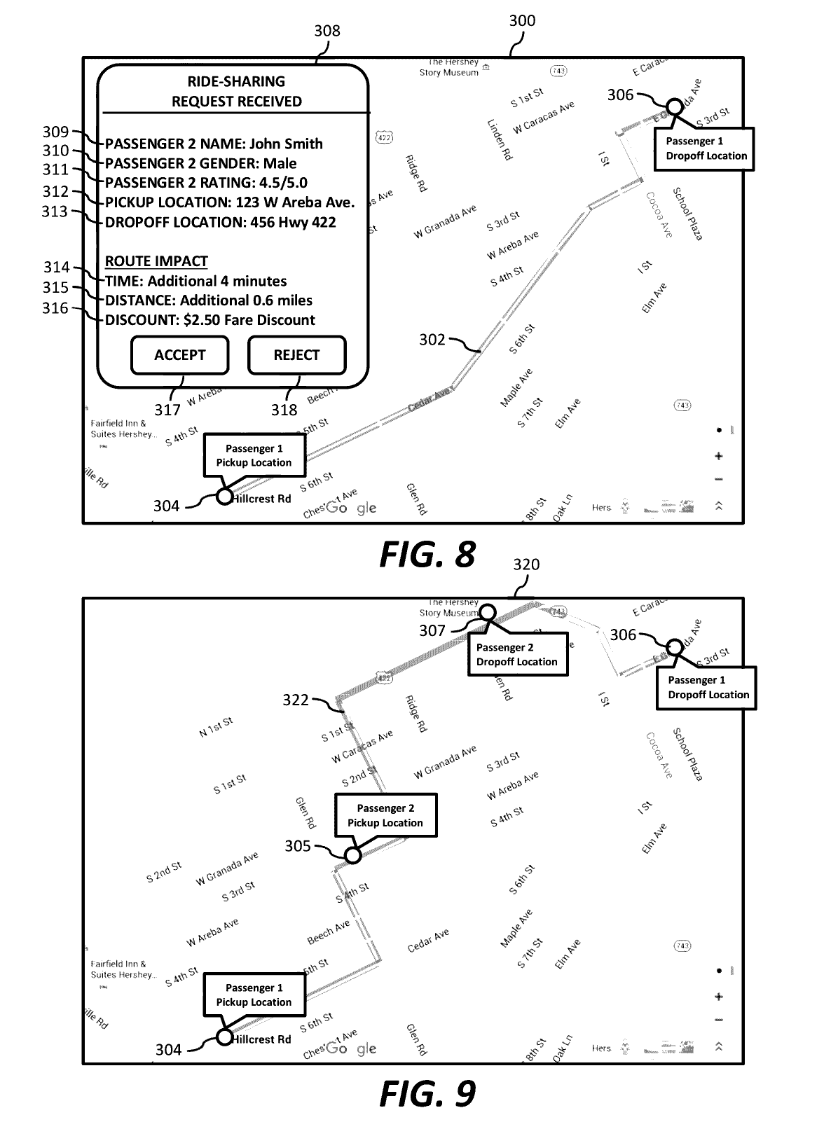

FIGS. 8 and 9 provide respective first and second example overviews 300 and 320 of adjusting a ride-sharing route according to example aspects of the present disclosure. In some examples, overviews 300 and 320 can correspond to graphical user interfaces that are provided for display as part of a ride-share scheduling system through which potential passengers or other users can set up a ride-sharing route and schedule. For instance, FIG. 8 depicts a ride-sharing route 302 set up for Passenger 1 to travel between a pickup location 304 and a dropoff location 306. The setup of an initial ride-sharing route can be implemented via an internet-accessible website or other application on a computing device accessible by the initial passenger(s).

A given ride-sharing vehicle for which ride-sharing route 302 is established can correspond to any number of transportation options having flexibility in travel location, including but not limited to a bus, car, van, truck, taxi, train, trolley or the like. Aspects of the disclosed embodiments can be advantageously utilized for mixed-use transportation services. Carpools, taxis with drivers, and/or autonomous vehicles can all participate in a ride-share scheduling system with enhanced features according to the disclosed embodiments. The given ride-sharing vehicle can be identified as having a predetermined capacity (e.g., 4 passengers in a sedan). Based on the predetermined capacity of the given ride-sharing vehicle, a determination can be made for the given ride-sharing route 302 regarding whether there is or will be additional capacity beyond an initial number of ride-share passengers and a driver for non-autonomous ride-sharing vehicles.

Potential additional passengers can access the same ride-share scheduling system accessed by the initial passenger(s) to submit a ride-sharing request. Ride-sharing requests can cause an existing ride-sharing route and schedule to be adjusted to accommodate the potential additional passenger(s). This dynamic route adjustment can occur in real time at one or more time periods including before a ride-sharing vehicle is dispatched, while the ride-sharing vehicle is en route to one or more pickup locations of the initial passengers, and/or while the ride-sharing vehicle is en route to one or more dropoff locations of the initial passengers. If additional capacity exists in a given ride-sharing vehicle, and the potential additional passenger(s) requests travel within a predetermined geographic proximity to the ride-sharing route, then consideration of a ride-sharing request can be enabled according to disclosed techniques. A comparison between the requested pickup and dropoff times of initial passenger(s) and potential additional passenger(s) can also be implemented to ensure that adjustment of only appropriate ride-sharing routes and/or schedules is considered.

Referring still to FIG. 8, a ride-sharing request can be received from Passenger 2 requesting travel from a pickup location of 123 W. Areba Ave. to a dropoff location of 456 Highway 422 (depicted in FIG. 9 as pickup location 305 and dropoff location 307). Assuming that certain basic criteria are met (e.g., similarity in route location and times), a ride-sharing request from one or more potential additional passengers can be shared with initial passengers. In the example of FIGS. 8 and 9, a ride-sharing request notification 308 is provided for display to Passenger 1 indicating that a ride-sharing request has been received from Passenger 2. Ride-sharing request notification 308 can include a plurality of identification variables to assist initial passengers (e.g., Passenger 1) in making a determination as to whether to accept or reject the ride-sharing request. For instance, a potential additional passenger name identifier 309 indicates that Passenger 2 is “John Smith.” A potential additional passenger gender identifier 310 indicates that Passenger 2 is a male. A potential additional passenger rating identifier 311 indicates that Passenger 2 has received a rating of 4.5 out of 5.0 on a predetermined rating scale accessible by previous passengers who have joined a ride share with Passenger 2. Potential additional passenger pickup location identifier 312 and potential additional passenger dropoff location identifier 313 can also be included within notification 308 (as illustrated) or on the map showing ride-sharing route 302.

Ride-sharing request notification 302 can also include one or more route impact identification variables indicating the impact that granting a ride-sharing request would have on the ride-sharing route. For instance, as shown in FIG. 8, a time impact identifier 314 and distance impact identifier 315 can indicate to Passenger 1 that accepting the ride-sharing request would add an additional time of four minutes and an additional distance of 0.6 miles to the ride-sharing route 302. A fare discount identifier 316 can indicate to Passenger 1 that his fare for ride-sharing route 302 would be discounted or reduced by $2.50 by accepting the ride-sharing request. In some examples, additional identifiers pertaining to the potential additional passenger(s) and/or route impact other than those depicted in FIG. 8 can be shown as part of ride-sharing request notification 302.

Passenger 1 can analyze the information provided within ride-sharing request notification 302 and make a decision to either accept the ride-sharing request by selecting “Accept” button 317 or reject the ride-sharing request by selecting “Reject” button 318. If the ride-sharing request is accepted by Passenger 1, then ride-sharing route 302 of FIG. 8 is modified to create an adjusted ride-sharing route 322 as shown in FIG. 9. Overview 320 depicting the adjusted ride-sharing route 322 can be provided for display to initial passengers of the ride-sharing route (e.g., Passenger 1) as well as the accepted additional passengers (e.g., Passenger 2).

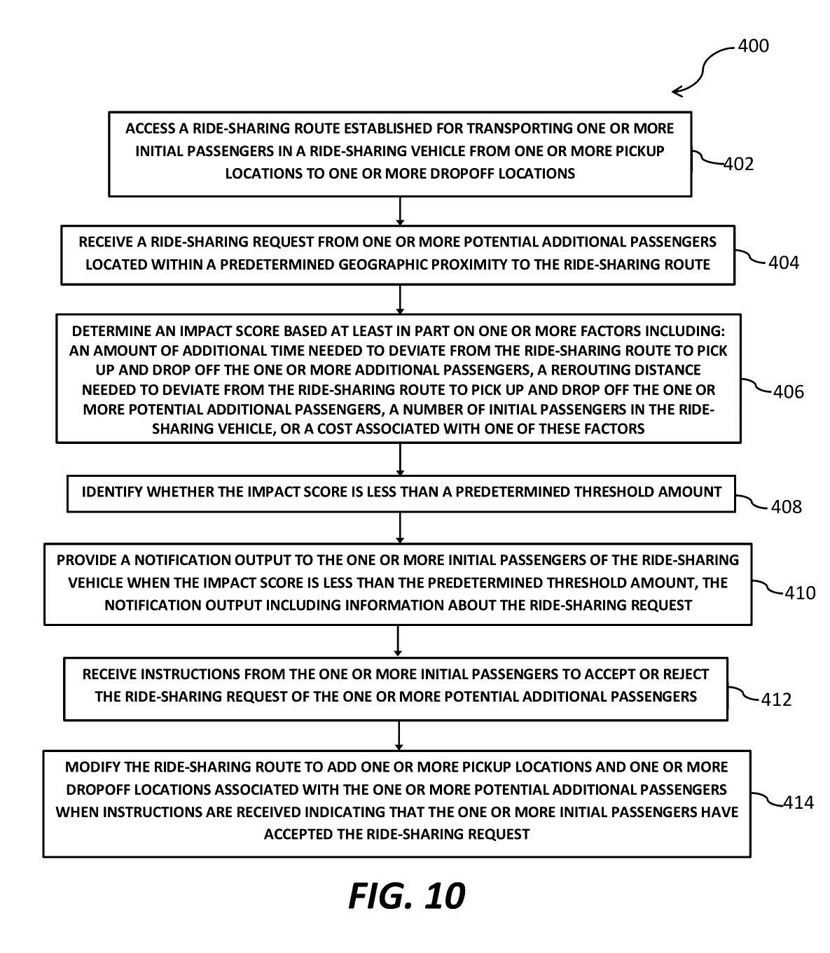

Referring now to FIG. 10, an example method (400) for adjusting ride-sharing routes includes accessing (402) a ride-sharing route established for transporting one or more initial passengers in a ride-sharing vehicle. Similar to the ride-sharing route 302 shown in FIG. 8, the ride-sharing route accessed at (402) can include one or more pickup locations and one or more dropoff locations (e.g., pickup location 304 and dropoff location 306 for Passenger 1). Method (400) also can include receiving (404) a ride-sharing request from one or more potential additional passengers located within a predetermined geographic proximity to the ride-sharing route accessed at (402). In the example of FIGS. 8 and 9, a ride-sharing request received at (404) would correspond to the request received from Passenger 2.

The ride-sharing route accessed at (402) and the ride-sharing request received at (404) can both originate from an online ride-share scheduling system or other internet-accessible application or website. The ride-share scheduling system can be provided as a stand-alone system or application or as part of a mapping application, navigation application, or other pre-existing location-based system. Ride-sharing routes accessed at (402) and ride-sharing requests received at (404) can be accessed and received at a variety of particular times. In some examples, ride-sharing routes can be scheduled in advance and notifications of ride-sharing requests can also be coordinated in advance such that notifications and modifications to a route are made before one or more initial passengers are picked up. In other examples, ride-sharing routes can be modified during a planned ride-sharing route or after all or parts of a ride-sharing route are completed.

A variety of implementation features can be provided as part of a ride-share scheduling system to facilitate coordination among users. For instance, user access to a ride-share scheduling system can be coordinated by including features by which a user can selectively consent to use of data including relevant location data, profile data, schedule data and other information with a ride-share scheduling system. Ride-sharing routes can be set up in a manner that preserves anonymity of initial contacts by creating unique subscriber email addresses that go through a proxy service. In this way, passengers or other users can communicate anonymously with other users until they decide to reveal their personal information. Passengers can be provided with ride-share route options including an indication of whether or not they would like to be a driver, a passenger or both. Passengers can be provided with ride-share route options that create routes as a one-time travel event or a repeat event that can occur at predetermined intervals (e.g., every weekday morning at a given time, or once a month at dates and times identified by a user).

Referring still to FIG. 10, before initial passengers are made aware of the ride-sharing request received at (404), an impact score based on combinations of one or more relevant factors can be determined at (406). For instance, an impact score can be based at least in part on such factors as an amount of additional time needed to deviate from the ride-sharing route to pick up and drop off the one or more potential additional passengers, a rerouting distance needed to deviate from the ride-sharing route to pick up and drop off the one or more potential additional passengers, a number of initial passengers in the ride-sharing vehicle, user preferences of the one or more initial passengers and/or whether there is or will be additional passenger capacity in the ride-sharing vehicle at the time the ride-sharing request is received or at the time the potential additional passenger is requesting pickup. When additional passenger capacity is considered, vehicle capacity determinations can be made dynamically to determine vehicle capacity for a time when additional passengers are seeking a ride. As such, even in situations when a ride-sharing vehicle is full, capacity determinations can account for whether passengers will be dropped off before an additional pickup is requested.

The different factors that are used to determine the impact score at (406) can be combined in different weights according to a variety of specific formulas to best capture the impact to initial passengers of a ride-sharing route. For example, one or more factors such as but not limited to the additional time and/or additional distance required to reroute for a potential additional passenger can be multiplied by a passenger factor representing the number of initial passengers in the ride-sharing vehicle. This passenger factor weighting can help represent situations when it can be more costly to reroute a vehicle with multiple passengers than rerouting a vehicle with a single passenger.

Method (400) then can include identifying (408) whether the impact score determined at (406) is less than a predetermined threshold amount. In some examples, the predetermined threshold amount can depend on one or more factors such as the ride-sharing route and preferences or schedules associated with the initial passenger(s). For instance, the predetermined threshold amount can be set to require a lower impact score if an initial passenger is taking a ride-share to the airport on a tight schedule and cannot be late. In some examples, identifying whether the impact score is less than a predetermined threshold amount includes comparing the impact score with a price value associated with the one or more initial passengers, wherein the price value is related to an adjustment in fare amount available to the initial passengers for accepting the ride-sharing request of the one or more potential additional passengers. When an impact score is identified at (408) to be less than the predetermined threshold amount, such identification is intended to indicate that the potential impact to initial passengers of a ride-sharing route might be less than a potential benefit in reduced fare discount available to the initial passenger(s) by accepting the potential additional passengers into the ride-sharing route.

If the impact score is identified at (408) to be less than the predetermined threshold amount, then a notification output can be provided for display at (412) to the one or more initial passengers of the ride-sharing vehicle. An example of a notification output provided for display at (410) is the ride-sharing request notification 308 depicted in FIG. 8. In some examples, a notification output provided at (410) can include information about the ride-sharing request received at (404), including but not limited to information about the potential additional passenger(s) including profile demographics. Profile demographics such as gender, age, passenger-to-passenger ratings and the like can help address potential awkwardness of sharing a ride with strangers or incompatible people. For instance, a single female traveling alone might choose not to share a vehicle with an unknown male, but might opt to share a vehicle with another single female. Additional profile demographics can also be added or customized, for example, preferences not to chat with other passengers, etc.

In some examples, a notification output provided at (410) can include information about the pickup and dropoff locations of the potential additional passenger(s). In some examples, a notification output provided at (410) can include an indication of an expected amount of additional time needed to deviate from a ride-sharing route to pick up and drop off the one or more potential additional passengers. A notification output provided at (410) also can include a fare adjustment or discount amount available to the initial passengers for accepting the ride-sharing request of the one or more potential additional passengers. In some examples, alternative benefits to fare discounts can be provided. For instance, passengers can earn points or coupons to use towards the cost of future rides, free rides, etc. Ride-sharing requests initiated by one or more potential additional passenger(s) may have an option to increase the amount of fare discount or other benefit offered to the initial passenger(s). Options to offer increased discount or benefit amounts can be advantageous to the initial passenger(s) receiving the benefits as well as to the potential additional passenger(s) when in a significant hurry.

Referring still to FIG. 10, instructions can be received at (412) from the initial passenger(s) indicating their response to the notification output provided at (410). The instructions received at (412) can include an indication of whether the initial passenger(s) accept or reject the ride-sharing request of the potential additional passenger(s). If instructions are received at (412) indicating that all or a majority of the initial passenger(s) have accepted the ride-sharing request, then the ride-sharing route can be modified at (414) to add one or more pickup locations and one or more dropoff locations associated with the potential additional passenger(s). Modifications to a ride-sharing route implemented at (414) can include autonomous vehicles receiving updated route information in response to instructions received at (412). If one or more initial passengers are in a hurry, prefer not to share their ride-sharing route, or have other reasons for rejecting the ride-sharing request, there would be no negative impact. The initial passenger can simply opt-out by rejecting the ride-sharing request and the potential additional passenger(s) would be paired up with a different ride-sharing vehicle and route dispatch.

When ride-sharing vehicles are rerouted in response to an accepted ride-sharing request, several carpooling advantages can be attained. For instance, the transportation company and/or the passengers in the ride-sharing route benefit from additional earned revenue on a route. Passengers can benefit from taking part in the savings to the transportation company translated as fare discounts, earned points, or the like. Vehicle occupancy and efficiency will increase due to the win-win scenario created for both a vehicle owner/operator and the passengers.

FIG. 11 depicts a computing system 500 that can be used to implement the methods and systems for requesting adjustments to ride-sharing routes and schedules according to example embodiments of the present disclosure. The system 500 can be implemented using one or more computing devices in communication over a network 502. Some computing devices can be associated with initial passengers 504, 506 and 508 of a ride-sharing route, while other computing devices can be associated with each potential additional passenger 510. In some examples, initial passengers 504, 506 and 508 are en route on a ride-sharing vehicle that includes a computing device as part of a vehicle scheduling system 514. In other examples, the initial passengers 504, 506 and 508 communicate directly via network 502 to set up a ride-sharing route before becoming vehicle passengers. System 500 also can include computing devices associated with a central scheduling system 512 and a vehicle scheduling system 514.

Computing devices associated with the passengers, vehicles, and central locations can be variously implemented in a client-server architecture. For instance, a computing device associated with central scheduling system 512 can correspond in some examples to a server, while computing devices associated with the passengers can correspond to clients. Client devices associated with each passenger 504-510 can access a ride-sharing application hosted on a server device, such as central scheduling system 512, in order to request ride-sharing schedule and/or route adjustments as described herein. Vehicle scheduling system 514 can correspond to a server device and/or a client device. For example, a vehicle driver may operate a computing device that is similar to the ones operated by vehicle passengers. Alternatively, vehicle scheduling system 514 can include a server device with input and output interface components that are accessible to the vehicle driver or operator.

An example client device corresponds to mobile computing device 560 depicted in FIG. 12 and an example server device corresponds to scheduling system computing device 580 of FIG. 13. In some examples, scheduling system computing devices could alternatively be implemented as client devices, and vice versa. In some examples, multiple computing devices optionally may be provided at one or more locations for operation in sequence or parallel configurations to implement the disclosed methods and systems of adjusting ride-sharing routes and schedules. Each of the computing devices 560, 580 can be any suitable type of computing device, such as a general purpose computer, special purpose computer, navigation system (e.g. an automobile navigation system), laptop, desktop, mobile device, smartphone, tablet, wearable computing device, a display with one or more processors, or other suitable computing device.

The computing devices 560 and/or 580 of FIGS. 12 and 13 can respectively include one or more processor(s) 576, 582 and one or more memory devices 566, 584. The one or more processor(s) 576, 582 can include any suitable processing device, such as a microprocessor, microcontroller, integrated circuit, logic device, one or more central processing units (CPUs), graphics processing units (GPUs) dedicated to efficiently rendering images or performing other specialized calculations, and/or other processing devices. The one or more memory devices 566, 584 can include one or more computer-readable media, including, but not limited to, non-transitory computer-readable media, RAM, ROM, hard drives, flash drives, or other memory devices. In some examples, memory devices 566, 584 can correspond to coordinated databases that are split over multiple locations.

The one or more memory devices 566, 584 store information accessible by the one or more processors 576, 582 including instructions (e.g., instructions 588) that can be executed by the one or more processors 576, 582. For instance, memory device 584 associated with scheduling system computing device 580 can store instructions 588 for implementing a ride-share scheduling and adjustment request application configured to perform various functions disclosed herein. The memory device 566 associated with mobile computing device 560 can store instructions for implementing a browser or application that allows a user to set up an initial ride-sharing route and/or request ride-sharing route and/or schedule adjustments via a ride-share scheduling system.

The one or more memory devices 566, 584 also can include data (e.g., data 586) that can be retrieved, manipulated, created, or stored by the one or more processors 576, 582. The data 586 stored at scheduling system computing device 580 can include, for instance, a database of listing information for predetermined or newly created ride-sharing schedules and routes. Data 586 stored at scheduling system computing device 580 or data stored at mobile computing device 560 can include profile data describing various demographics of passengers or other users of the ride-share scheduling systems.

Mobile computing devices 560 and/or scheduling system computing devices 580 can communicate with one another over a network, such as network 502 depicted in FIG. 11. In such instances, the mobile computing device 560 and scheduling system computing device 580 can also respectively include a network interface (e.g., communication device 568) used to communicate with one another over network 502. The network interface(s) can include any suitable components for interfacing with one more networks, including for example, transmitters, receivers, ports, controllers, antennas, or other suitable components. The network 502 can be any type of communications network, such as a local area network (e.g. intranet), wide area network (e.g. Internet), cellular network, or some combination thereof. The network 502 can also include a direct connection between one or more mobile computing devices 560 and one or more scheduling system computing devices 580. In general, communication among computing devices can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

Each mobile computing device 560 can include various input/output devices for providing and receiving information to/from a user. For instance, an input device 570 can include devices such as a touch screen, touch pad, data entry keys, and/or a microphone suitable for voice recognition. Input device 570 can be employed by a user to request ride-sharing route and schedule setups and adjustments in accordance with the disclosed embodiments, or to request the display of maps or other features illustrating ride-sharing features generated in accordance with the disclosed embodiments. An output device 572 can include audio or visual outputs such as speakers or displays for providing various user interfaces in accordance with the disclosed ride-share scheduling systems, and/or notification outputs including but not limited to ride-sharing schedule and route adjustment requests and responses.

Each mobile computing device 560 can also include one or more location sensors 574, one or more power devices 562 and/or one or more sensors 564. Location sensor(s) 574 can be configured to determine a user's current geographic location to assist with ride-sharing schedule coordination. Location sensor(s) 574 can include a GPS device, Bluetooth low energy (BLE) beacon detector, accelerometer, wireless network identifier, cell phone multilateration device, or other location determination hardware devices or software-implemented technology. Power device(s) 562 can include any type of energy storage device such as a battery or capacitive device, which optionally can be rechargeable. Sensor(s) 564 optionally can include a variety of devices, including but not limited to a motion sensor, orientation sensor, audio sensor and/or an image sensor.

It will be appreciated that the computer-executable algorithms described herein can be implemented in hardware, application specific circuits, firmware and/or software controlling a general purpose processor. In one embodiment, the algorithms are program code files stored on the storage device, loaded into one or more memory devices and executed by one or more processors or can be provided from computer program products, for example computer executable instructions, that are stored in a tangible computer-readable storage medium such as RAM, flash drive, hard disk, or optical or magnetic media. When software is used, any suitable programming language or platform can be used to implement the algorithm.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of adjusting ride-sharing schedules, comprising:
accessing, by one or more computing devices, a ride-sharing schedule for a ride-sharing vehicle, wherein the ride-sharing schedule includes planned stops for one or more route locations at one or more predetermined stop times;
receiving, by one or more computing devices, an adjustment request for the ride-sharing schedule, wherein the adjustment request seeks adjustment of one or more of the route locations or the predetermined stop times of the ride-sharing schedule;
determining, by the one or more computing devices, an adjustment cost associated with the adjustment request, wherein the adjustment cost is indicative of the impact of the adjustment request to initial passengers of the ride-sharing vehicle;
generating, by the one or more computing devices, an adjustment request response based at least in part on the adjustment cost, wherein the adjustment request response includes an indication of a decision relative to the adjustment request; and
providing, by the one or more computing devices, the adjustment request response as a notification output.

2. The computer-implemented method of claim 1, wherein the adjustment request response includes an indication of a decision comprising one or more of: a decision to grant the adjustment request in full, a decision to grant the adjustment request in part, or a decision not to grant the adjustment request.

3. The computer-implemented method of claim 1, further comprising:
accessing, by the one or more computing devices, a first geographic location associated with the ride-sharing vehicle;
accessing, by the one or more computing devices, a second geographic location associated with a potential additional passenger of the ride-sharing vehicle; and
determining, by the one or more computing devices, a first travel time between the first geographic location and a selected one of the route locations and a second travel time between the second geographic location and the selected one of the route locations;
wherein the adjustment cost is determined based at least in part on the first travel time and the second travel time.

4. The computer-implemented method of claim 1, wherein the adjustment request comprises an estimated arrival time of a potential additional passenger of the ride-sharing vehicle to a predetermined route location selected from among the one or more route locations, and wherein the adjustment cost is based at least in part on a calculated time difference between the estimated arrival time of the potential additional passenger of the ride-sharing vehicle and the predetermined stop time for the predetermined route location.

5. The computer-implemented method of claim 1, wherein the adjustment request comprises an additional fare amount willing to be paid by an potential additional passenger of the ride-sharing vehicle to obtain the adjustment request, and wherein the adjustment cost is based at least in part on the additional fare amount.

6. The computer-implemented method of claim 1, further comprising receiving, by the one or more computing devices, an approval response from initial passengers of the ride-sharing vehicle indicating their vote relative to the adjustment request, and wherein the adjustment cost is based at least in part on approval responses received from initial passengers.

7. The computer-implemented method of claim 1, wherein the adjustment cost is based at least in part on one or more of: a number of initial passengers on the ride-sharing vehicle, a number of times that the potential additional passenger of the ride-sharing vehicle has previously provided an adjustment request, an indication that the potential additional passenger of the ride-sharing vehicle is handicapped, or a current state of the ride-sharing vehicle.

8. The computer-implemented method of claim 1, wherein the adjustment request response is provided by the one or more computing devices as a notification output to the ride-sharing vehicle and includes one or more of a notification of the number of potential additional passengers that should be picked up at a route location in response to the adjustment request, a notification of an adjusted arrival time at a route location in response to the adjustment request, or a notification of an adjusted departure time at a route location in response to the adjustment request.

9. The computer-implemented method of claim 1, wherein the adjustment request response is provided by the one or more computing devices as a notification output to a mobile device associated with the potential additional passenger of the ride-sharing vehicle.

10. The computer-implemented method of claim 1, further comprising initiating, by the one or more computing devices, a dispatch request for alternative transportation arrangements when the adjustment request response includes an indication of a decision not to grant the adjustment request.

11. The computer-implemented method of claim 1, further comprising adjusting, by the one or more computing devices, one or more stop times of the ride-sharing schedule for the ride-sharing vehicle when multiple adjustment requests are received from potential additional passengers of the ride-sharing vehicle at a particular route location.

12. The computer-implemented method of claim 1, wherein the adjustment request is received from the ride-sharing vehicle and wherein the adjustment cost is based at least in part on a current state of the ride-sharing vehicle.

13. A computer-implemented method of adjusting a ride-sharing route, comprising:
accessing, by one or more computing devices, a ride-sharing route established for transporting one or more initial passengers in a ride-sharing vehicle from one or more pickup locations to one or more dropoff locations;
receiving, by the one or more computing devices, a ride-sharing request from one or more potential additional passengers located within a predetermined geographic proximity to the ride-sharing route;
determining, by the one or more computing devices, an impact score based at least in part on one or more factors including: an amount of additional time needed to deviate from the ride-sharing route to pick up and drop off the one or more potential additional passengers, a rerouting distance needed to deviate from the ride-sharing route to pick up and drop off the one or more potential additional passengers, or a number of initial passengers in the ride-sharing vehicle;
identifying, by the one or more computing devices, whether the impact score is less than a predetermined threshold amount; and
providing, by the one or more computing devices, a notification output to the one or more initial passengers of the ride-sharing request when the impact score is less than the predetermined threshold amount.

14. The computer-implemented method of claim 13, further comprising receiving, by the one or more computing devices, instructions from the one or more initial passengers indicating a response of the one or more initial passengers to accept or reject the ride-sharing request of the one or more potential additional passengers.

15. The computer-implemented method of claim 14, further comprising modifying, by the one or more computing devices, the ride-sharing route to add one or more pickup locations and one or more dropoff locations associated with the one or more potential additional passengers when instructions are received indicating that one or more initial passengers have accepted the ride-sharing request.

16. The computer-implemented method of claim 14, wherein determining, by the one or more computing devices, an impact score comprises determining an amount of additional time needed to deviate from the ride-sharing route to pick up and drop off the one or more potential additional passengers and multiplying the amount of additional time by the number of initial passengers in the ride-sharing vehicle.

17. The computer-implemented method of claim 13, further comprising determining, by the one or more computing devices, whether there is additional passenger capacity in the ride-sharing vehicle at a time the ride-sharing request is received or at a time for which the potential additional passenger is requesting pickup.

18. The computer-implemented method of claim 13, wherein the notification output provided to the one or more initial passengers comprises an expected amount of additional time needed to deviate from the ride-sharing route to pick up and drop off the one or more potential additional passengers and a fare adjustment amount available to the initial passengers for accepting the ride-sharing request of the one or more potential additional passengers.

19. The computer-implemented method of claim 13, wherein the notification output provided to the one or more initial passengers comprises one or more profile demographics of the one or more potential additional passengers.

20. The computer-implemented method of claim 13, wherein determining, by the one or more computing devices, an impact score is further based at least in part on one or more user preferences of the one or more initial passengers.

21. The computer-implemented method of claim 13, wherein the method of adjusting a ride-sharing route is implemented at one or more of the following times: before the ride-sharing vehicle is dispatched, while the ride-sharing vehicle is en route to the one or more pickup locations of the initial passengers, or while the ride-sharing vehicle is en route to the one or more dropoff locations of the initial passengers.

22. The computer-implemented method of claim 13, wherein identifying, by the one or more computing devices, whether the impact score is less than a predetermined threshold amount comprises comparing the impact score with a price value associated with the one or more initial passengers, wherein the price value is related to an adjustment in fare amount available to the initial passengers for accepting the ride-sharing request of the one or more potential additional passengers.

23. A computing device, comprising:
one or more processors; and
one or more memory devices, the one or more memory devices storing computer-readable instructions that when executed by the one or more processors, cause the one or more processors to perform operations, the operations comprising:
accessing a ride-sharing schedule for a ride-sharing vehicle, wherein the ride-sharing schedule includes planned stops for one or more route locations at one or more predetermined stop times;
receiving an adjustment request seeking adjustment of one or more of the route locations or the predetermined stop times of the ride-sharing schedule;
determining an adjustment cost associated with the adjustment request, wherein the adjustment cost is indicative of the impact of the adjustment request to initial passengers of the ride-sharing vehicle;
generating an adjustment request response based at least in part on the adjustment cost, wherein the adjustment request response includes an indication of a decision comprising one or more of: a decision to grant the adjustment request in full, a decision to grant the adjustment request in part, or a decision not to grant the adjustment request; and
providing the adjustment request response as a notification output.

24. The computing device of claim 23, wherein the adjustment request comprises an additional fare amount willing to be paid by an potential additional passenger of the ride-sharing vehicle to obtain the adjustment request, and wherein the adjustment cost is based at least in part on the additional fare amount.

25. The computing device of claim 23, wherein the operations further comprise receiving an approval response from initial passengers of the ride-sharing vehicle indicating their vote on one or more of: a decision to grant the adjustment request in full, a decision to grant the adjustment request in part, or a decision not to grant the adjustment request, and wherein the adjustment cost is based at least in part on the approval responses received from initial passengers.

26. The computing device of claim 23, wherein the adjustment cost is based at least in part on one or more of: a number of initial passengers on the ride-sharing vehicle, a number of times that the potential additional passenger of the ride-sharing vehicle has previously provided an adjustment request, an indication that the potential additional passenger of the ride-sharing vehicle is handicapped, or a current state of the ride-sharing vehicle.

27. The computing device of claim 23, wherein the adjustment request seeks to modify the ride-sharing schedule to add one or more pickup locations and one or more dropoff locations associated with one or more potential additional passengers.

28. The computing device of claim 27, wherein determining an adjustment cost comprises determining an expected amount of additional time needed to deviate from the ride-sharing schedule to pick up and drop off the one or more potential additional passengers and a fare adjustment amount available to initial passengers of the ride-sharing vehicle.

29. The computing device of claim 27, wherein the adjustment cost is based at least in part on one or more profile demographics of the one or more potential additional passengers or one or more user preferences of the one or more initial passengers.
